(19) United States
(12) Patent Application Publication
(10) Pub. No.: US 2025/0308877 A1
(43) Pub. Date: Oct. 2, 2025

(54) HYBRID INDUCTIVELY COUPLED PLASMA MASS SPECTROMETER (ICP-MS) AND METHODS

(71) Applicant: Kimia Analytics Inc., Richmond Hill (CA)

(72) Inventors: Sina ALAVI, North York (CA); Gholamreza JAVAHERY, Thornhill (CA)

(73) Assignee: Kimia Analytics Inc., Richmond Hill (CA)

(21) Appl. No.: 19/090,946

(22) Filed: Mar. 26, 2025

Related U.S. Application Data
(60) Provisional application No. 63/572,478, filed on Apr. 1, 2024.

(51) Int. Cl. H01J 49/10; H01J 49/00; H01J 49/24

(52) U.S. Cl. CPC H01J 49/105; H01J 49/0031; H01J 49/0077; H01J 49/0095; H01J 49/24

(57) ABSTRACT

A hybrid inductively coupled plasma mass spectrometer (ICP-MS) system is disclosed for simultaneous elemental and molecular analysis in positive and negative polarities. It includes an ICP torch that generates plasma with a buffer gas, producing both positively and negatively charged ions from a sample. Positioned between the sampler and skimmer, an insert with a defined geometry forms a reaction chamber. Various embodiments feature multiple apertures for pressure control, a rotatable disk for aperture regulation, a slider gate for pressure adjustment, a circular gate with adjustable radial apertures, and an inlet for introducing gases, reagents, dopants, or analytes. These components enable precise pressure modulation, optimizing performance for dual-polarity mass spectrometry. The system enhances analytical flexibility by facilitating controlled ion reactions, improving sensitivity and specificity for both elemental and molecular applications. This innovation expands ICP-MS functionality, supporting diverse scientific and industrial applications requiring high-precision mass analysis.

### FIELD OF THE INVENTION

The present invention generally relates to a method of mass spectrometry and a mass spectrometer, and particularly to a hybrid system that can be switched to detect positive or negative ions.

### BACKGROUND OF THE INVENTION

Inductively Coupled Plasma Mass Spectrometry (ICP-MS) stands as a cornerstone in the realm of analytical chemistry, offering unparalleled capabilities in elemental analysis across diverse fields. This sophisticated technique harnesses the power of a high temperature plasma (i.e., ICP) and mass spectrometry to precisely quantify trace elements within a sample, with sensitivity reaching parts-per-trillion to parts-per-quadrillion levels. Since its inception, ICP-MS has become an indispensable tool in various scientific disciplines, including environmental monitoring, semiconductor testing, clinical and biomedical applications, pharmaceuticals, geology, forensic science, and beyond.

The significance of ICP-MS lies in its ability to provide highly sensitive, accurate, and simultaneous multi-element analysis from a wide range of sample types. By employing a high temperature inductively coupled plasma (ICP) as the ionization source, ICP-MS generates ions from the sample's elements, which are subsequently separated, identified, and quantified based on their mass-to-charge ratios. This technique enables the detection and quantification of elements across the entire periodic table, spanning from alkali metals to rare earth elements and beyond, with exceptional precision and speed.

Furthermore, ICP-MS offers unparalleled versatility, allowing for the analysis of various sample matrices. Its capability to handle complex matrices makes it invaluable in fields like environmental analysis, where trace element determination in soil and water samples is crucial for understanding environmental pollution and human health risks. ICP-MS plays a crucial role in water testing due to its exceptional sensitivity and ability to detect a wide range of elements at trace levels. Water quality assessment is essential for safeguarding public health and ensuring environmental sustainability, and ICP-MS enables comprehensive analysis of contaminants such as heavy metals, metalloids, and rare earth elements. Whether monitoring drinking water sources, assessing wastewater treatment effectiveness, or investigating environmental pollutants, ICP-MS provides accurate and reliable quantification of potentially harmful substances. By identifying contaminants at ultra-low concentrations, ICP-MS empowers researchers, environmental agencies, and water treatment facilities to make informed decisions to protect both human health and aquatic ecosystems.

ICP-MS also plays a pivotal role in semiconductor testing, ensuring the quality and reliability of semiconductor materials crucial for modern electronics. Its high sensitivity and ability to detect trace elements at extremely low concentrations make it indispensable for identifying impurities that could jeopardize semiconductor performance. With the semiconductor industry's stringent purity requirements, ICP-MS provides accurate elemental analysis, enabling manufacturers to pinpoint contaminants originating from various sources such as manufacturing processes or raw materials. By precisely identifying impurities, ICP-MS assists in maintaining semiconductor integrity, optimizing yields, and ultimately enhancing the functionality and longevity of semiconductor devices essential for powering today's technological advancements.

With the increasing demand for lithium-ion batteries in various applications such as electric vehicles and portable electronics, ensuring their safety, reliability, and performance is paramount. ICP-MS enables precise elemental analysis of lithium and other battery components, identifying impurities that can impact battery efficiency, longevity, and safety. By detecting trace levels of contaminants, including metals and other impurities, ICP-MS helps researchers and manufacturers optimize battery materials and manufacturing processes, ultimately enhancing battery performance, durability, and safety standards.

In clinical applications, ICP-MS can revolutionize diagnostics and patient care. Its unparalleled sensitivity and capability to detect and quantify elements across a wide range enables precise analysis of biological samples such as blood, urine, and tissues. In clinical laboratories, ICP-MS serves as a vital tool for identifying trace elements and heavy metals that can indicate nutritional deficiencies, metabolic disorders, or toxic exposures. From monitoring essential elements like zinc and iron to detecting toxic metals such as lead and mercury, ICP-MS facilitates early disease detection and personalized treatment strategies. Moreover, its speed and accuracy streamline research efforts in understanding the role of elemental imbalances in various diseases, paving the way for innovative therapies and improved patient outcomes.

In the pharmaceutical industry, ICP-MS is utilized for quality control, determining trace metal impurities in drug formulations, and monitoring elemental content in biological samples for pharmacokinetic studies. ICP-MS is extensively used in geochemical research to analyze trace elements and isotopes in rocks, minerals, soils, and sediments. These analyses provide insights into geological processes, mineral exploration, and environmental geochemistry. Forensic analysts rely on ICP-MS for the analysis of trace elements in forensic evidence such as hair, blood, and soil. This aids in criminal investigations, identifying sources of evidence, and linking suspects to crime scenes.

While ICP-MS is a powerful analytical technique, it does have certain limitations. One notable limitation is the potential for spectral interferences, where the mass spectrometer mistakenly identifies ions from interfering species as the analyte of interest. This can lead to inaccurate quantification and misinterpretation of results, particularly in complex sample matrices containing high levels of background elements (isobaric interferences) and molecules (polyatomic interferences). Mitigating spectral interferences often requires careful and complicated method development, such as using collision/reaction cells or high resolution mass spectrometry to remove interfering ions or employing mathematical correction algorithms.

Additionally, ICP-MS requires specialized instrumentation and skilled operators, making it relatively expensive to acquire and maintain compared to other elemental analysis techniques. The complexity of the instrument setup, in addition to the need for a high-purity argon gas source and large water chillers for cooling the sampling interface, adds to the operational costs, footprint, and technical challenges. Furthermore, the instrument's sensitivity to matrix effects and sample preparation requirements can necessitate extensive method optimization and quality control measures, increasing both time and resource investments.

Another inherent limitation of ICP-MS is its inability to provide chemical information beyond elemental composition. While it excels at detecting and quantifying elements down to ultra-trace levels, it cannot distinguish between different chemical forms or oxidation states of an element present in a sample. This can be problematic when analyzing samples containing multiple species of the same element or when speciation information is critical for understanding biological or environmental processes. However, there are techniques that can be coupled with ICP-MS to provide some level of molecular information. One such technique is speciation analysis, which aims to determine the chemical forms (species) of elements present in a sample. Speciation analysis can be performed by coupling liquid chromatography (LC) or gas chromatography (GC) with ICP-MS (LC-ICP-MS or GC-ICP-MS). In LC-ICP-MS or GC-ICP-MS systems, the chromatography separates different chemical species before they enter the ICP-MS instrument. This separation allows for the identification and quantification of individual molecular species based on their retention times in the chromatographic column. For example, LC-ICP-MS can be used to analyze metal complexes, organometallic compounds, or metalloproteins in biological samples, while GC-ICP-MS can be applied to volatile metal species or organic compounds containing metals.

While these techniques provide valuable information, it is important to note that ICP-MS itself does not directly provide molecular analysis. Instead, it relies on chromatographic separation techniques to separate molecular species before detection. Therefore, while ICP-MS coupled with chromatography can provide insight into molecular species containing elements of interest, it does not offer direct molecular analysis in the same way as techniques like mass spectrometry-based methods such as electrospray ionization mass spectrometry (ESI-MS), electron-impact gas chromatography mass spectrometry (EI-GC-MS), or matrix-assisted laser desorption/ionization mass spectrometry (MALDI-MS). This inherent limitation is due to the nature of the ionization source used in ICP-MS. The ICP with its high temperatures (5000-10000 K) essentially decomposes molecules into their constituent ions, thereby stripping away any information regarding the sample's molecular structure. As a result, unlike other techniques which preserve molecular integrity and offer insights into molecular composition, ICP-MS is primarily focused on elemental analysis.

Here, we introduce the first ever hybrid ICP-MS system with multiple modes of analysis, equipped with a completely new sampling interface that enables the analysis of both elements and molecules in positive and negative modes. This system is also equipped with the capability to perform soft-ionization of molecular samples in addition to being able to provide full decomposition and ionization of the sample similar to a traditional ICP-MS. The soft ionization capability can ionize fragile molecules without fragmenting them, hence offering the capability to analyze intact molecules.

The new hybrid ICP-MS can also be coupled to a gas chromatograph to significantly extend the application of GC-MS when compared with traditional electron-impact-GC-MS (EI-GC-MS). This technique also improves the limits of detection of the MS device by many orders of magnitudes. This technique utilizes the high abundance of charged and/or electronically excited species and free electrons inside the hot plasma to create high yields of intact positive and negative molecular ions through soft ionization.

It is common practice in a lab to use different mass spectrometers for different sample types. For example, while ICP-MS is used for elemental analysis with samples that are mostly in the form of solutions, LC-MS and GC-MS are used for analysis of samples in their molecular form which are in liquid and gas/volatile phases, respectively. As a result, an analytical lab may need to have several different mass spectrometers or other types of analytical instruments to deal with different sample type, sample matrices, or analytes for different applications. In such a case, having access to a mass spectrometer that can combine some of the features of different mass spectrometers and handle different sample types would be highly valuable. This will lead to a reduction in cost, the number of operators with different skill sets, training in various technologies, system footprint to save valuable lab space, etc. The advent of a hybrid ICP-MS system capable of analyzing both elemental and intact molecular ions represents a groundbreaking advancement in analytical chemistry. This innovative technology combines the elemental analysis capabilities of traditional ICP-MS with the molecular analysis capabilities. By integrating these functionalities into a single platform, this hybrid system offers numerous advantages and opens new avenues for research and analysis across various fields.

The primary advantage of the hybrid ICP-MS system is its ability to provide comprehensive chemical characterization by simultaneously analyzing both elemental and molecular ions within a single sample. This holistic approach enables researchers to obtain a deeper understanding of sample composition and structure, facilitating more informed decision-making in fields such as pharmaceuticals, environmental science, and materials analysis. By incorporating multiple ionization modes, the hybrid ICP-MS system offers increased analytical flexibility compared to traditional ICP-MS instruments. Researchers can choose between elemental analysis or molecular analysis modes based on the specific requirements of their samples and research objectives. This versatility enhances the system's utility across a wide range of applications, from trace metal analysis to metabolomics and proteomics studies.

### SUMMARY OF THE INVENTION

A hybrid inductively coupled plasma mass spectrometer (ICP-MS) system is provided. This system allows for both elemental and molecular analysis all in one system. The system comprises of an ICP torch to generate a plasma with a buffer gas (M) to generate positively and negatively charged ions from a sample. The torch is secured on a torch housing which also holds a sampling interface. The sampling interface comprises of a sampler cone that has a sampler orifice and is placed in front of the plasma to intake ions generated by the plasma. A first vacuum stage created by a roughing pump with a pumping speed creates a first vacuum stage pressure of a few Torrs behind the sampler cone. A skimmer having an orifice placed behind the sampler orifice is provided to skim and partially intake the emerging flow of gas and ions from the sampler orifice. A second vacuum stage, behind the skimmer cone that is mounted on a skimmer mount that is pumped by a turbomolecular pump further reduces the pressure to avoid recombination and neutralization of the ions. An insert having an insert orifice, a geometry, and a form factor (shape design, i.e., cone having a cone angle and length to diameter ratio), is placed between the sampler cone and the skimmer. The insert is configured to create a reaction chamber between the sampler cone and the insert. The reaction chamber pressure is controlled by the insert orifice and the sampler orifice sizes and the pumping speed of the roughing pump. This allows the pressure inside the reaction chamber to be between a few to tens of Torrs or a few hundred Torrs higher. The insert orifice allows ions to pass through toward the skimmer orifice. By changing the pressure inside the reaction chamber, the ICP-MS mode can be change from elemental to molecular analysis.

In the elemental mode, the present hybrid ICP-MS system is configured to let the elemental ions of interest sampled from the plasma remain unmodified in order to increase the sensitivity and performance of the ICP-MS instruments for elemental analysis and to minimize the formation of any molecular species within various stages of the spectrometer as well as to keep oxide levels below 1-3%.

In the molecular mode, high pressures are generated in the reaction chamber, causing the unwanted positive ions generated by the plasma to be eliminated and prevented from entering the analyzing devices of the mass spectrometer. In addition, their charge can be utilized to ionize the analytes of interest in “positive” mode through charge transfer ion/chemistry reactions, the presence of excited neutral species (meta-stables).

In another embodiment of the present system, the insert has one or more apertures around its central orifice to adjust the pressure inside the reaction chamber.

In another embodiment of the present system, a rotatable disk is provided next to the insert to open and partially or fully close the apertures of the insert, thereby controlling the pressure inside the reaction chamber.

In another embodiment of the present system, instead of the insert, a slider gate having a set or opening is provided, which can slide between the sampler and the skimmer to generate a reaction chamber with a desired pressure.

In another embodiment of the present system, a circular gate having one or more radial apertures is provided in the first stage vacuum region to control the reaction chamber pressure. The circular gate comprises of two concentric rings, once rotating on another to open and close a set of openings of the circular gate, thereby controlling the pressure in the reaction chamber.

### DETAILED DESCRIPTION OF THE DRAWINGS

Embodiments herein will hereinafter be described in conjunction with the appended drawings provided to illustrate and not to limit the scope of the claims, wherein like designations denote like elements.

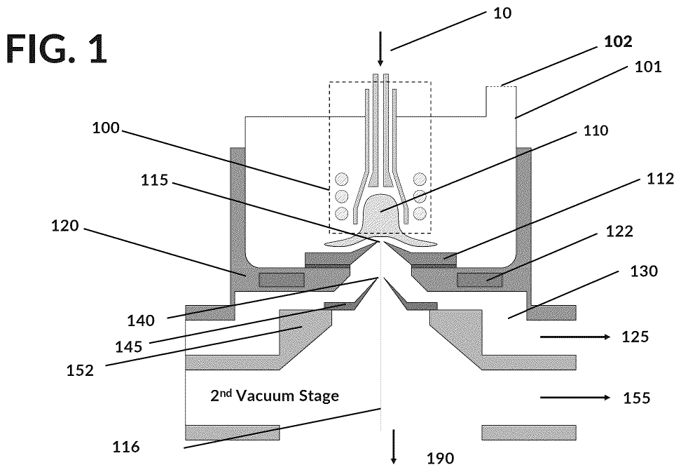

FIG. 1 shows a conventional ICP system;

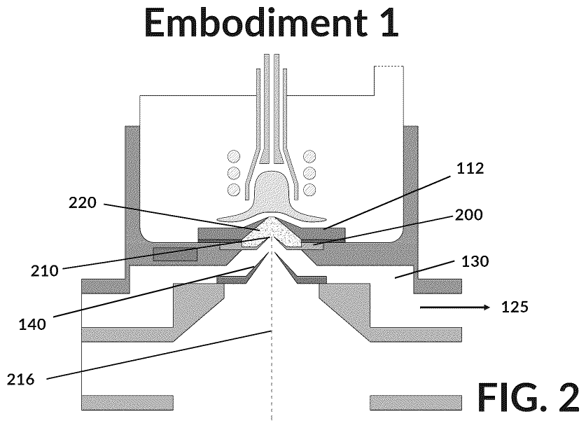

FIG. 2 shows one embodiment of the present hybrid ICP-MS system having an insert to generate a reaction chamber between the sampler cone and the skimmer cone;

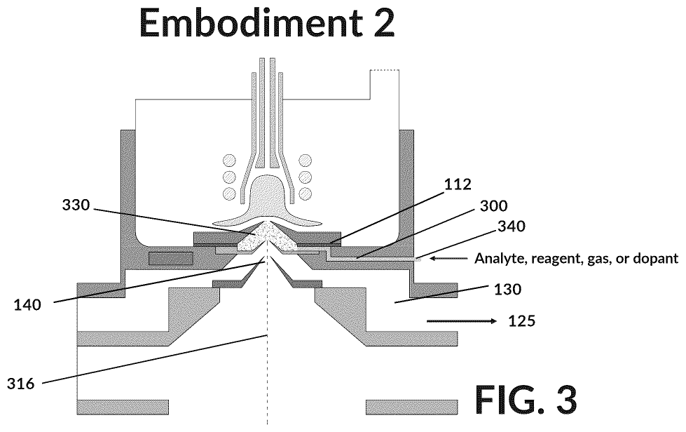

FIG. 3 shows another embodiment of the present hybrid ICP-MS system having an insert and channels for introducing reaction gases into the reaction chamber;

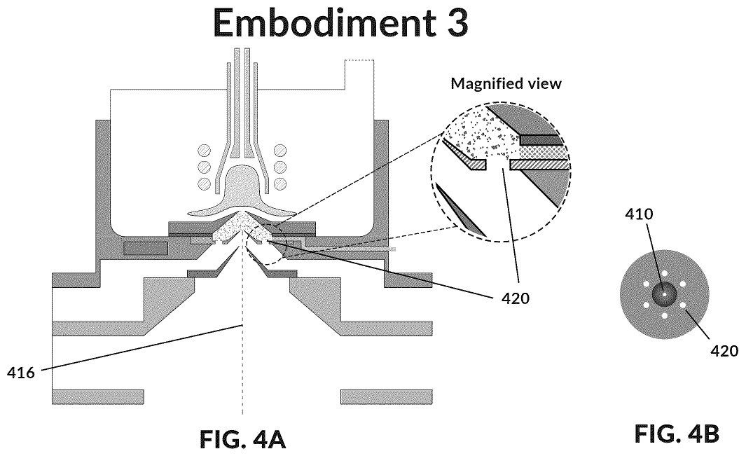

FIG. 4 shows another embodiment of the present hybrid ICP-MS system having an insert that has a number of apertures around the central orifice of the insert;

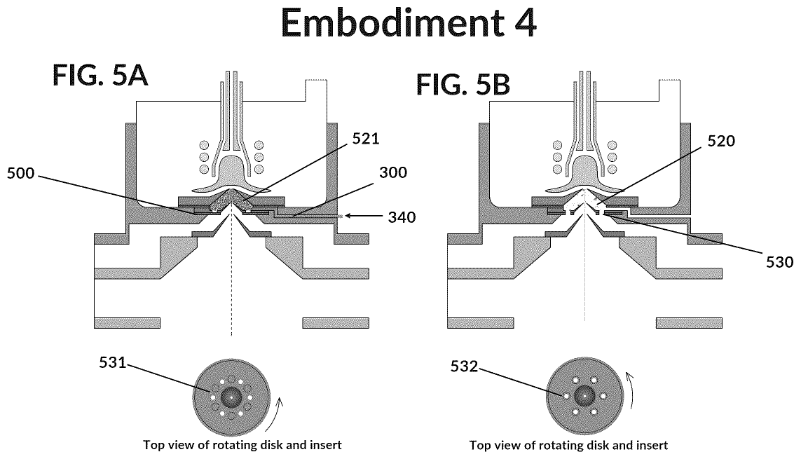

FIG. 5A shows another embodiment of the present hybrid ICP-MS system having a rotatable disk placed behind the insert and rotated to close the peripheral openings of the insert;

FIG. 5B shows another embodiment of the present hybrid ICP-MS system having a rotatable disk placed behind the insert and rotated to open the peripheral openings of the insert;

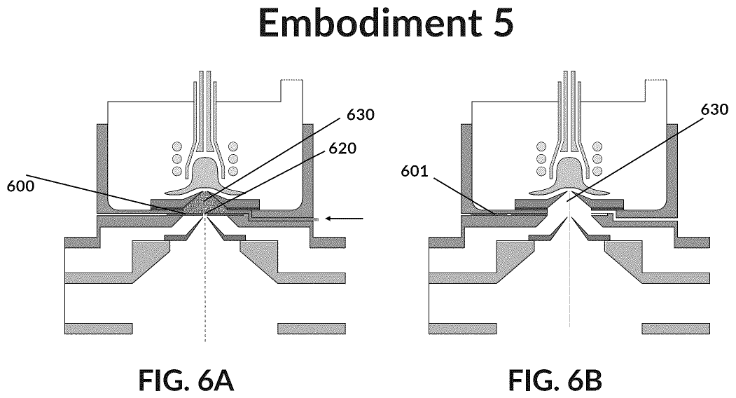

FIG. 6A shows another embodiment of the present hybrid ICP-MS system having a slider gate placed behind the insert and slide to close the peripheral openings of the insert;

FIG. 6B shows another embodiment of the present hybrid ICP-MS system having a slider gate placed behind the insert and slide to open the peripheral openings of the insert;

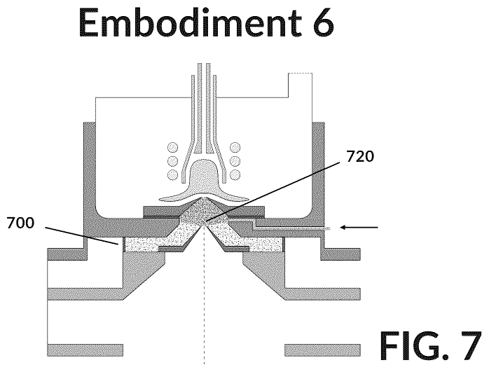

FIG. 7 shows another embodiment of the present hybrid ICP-MS system having a circular gate placed in the first vacuum stage configured to generate a reaction chamber between the sampler and skimmer cones;

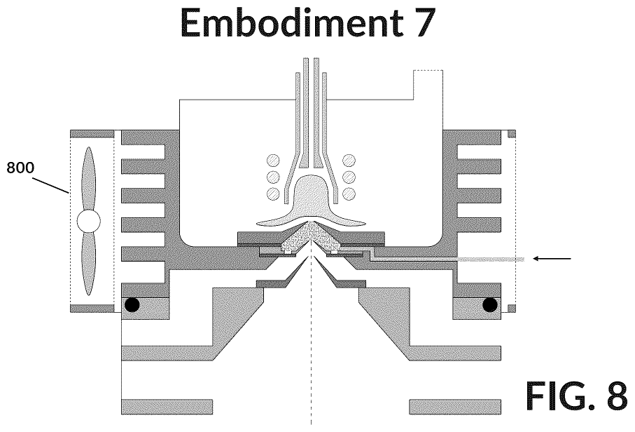

FIG. 8 shows another embodiment of the present hybrid ICP-MS system having an insert and being air cooled;

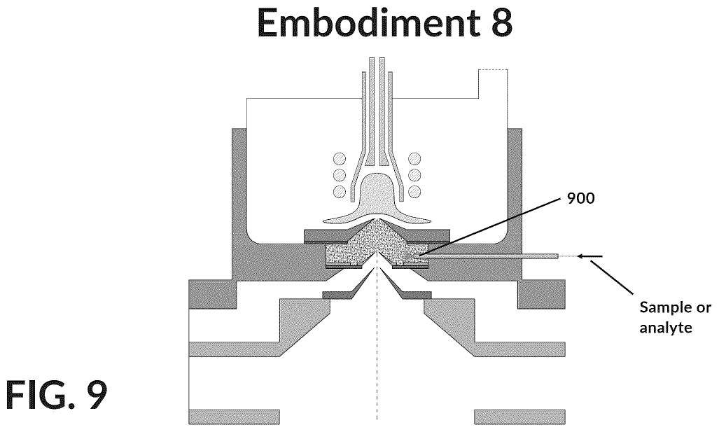

FIG. 9 shows another embodiment of the present hybrid ICP-MS system having an insert, channels for introducing reaction gases into the reaction chamber, wherein micro/nano spray is used to introduce analytes directly into the reaction chamber;

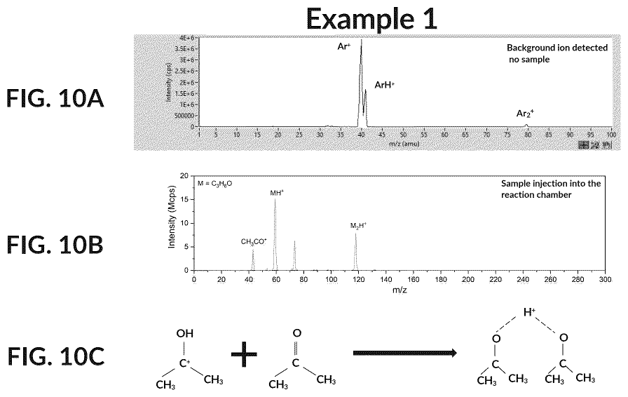

FIG. 10A shows a sample test result;

FIG. 10B shows a sample test result;

FIG. 10C shows a sample test result;

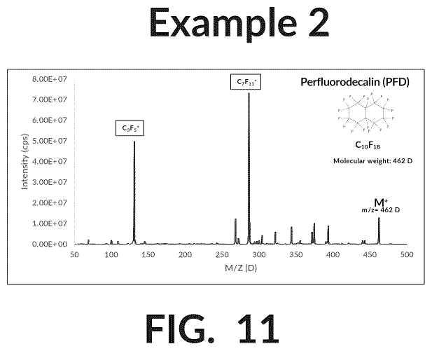

FIG. 11 shows a sample test result;

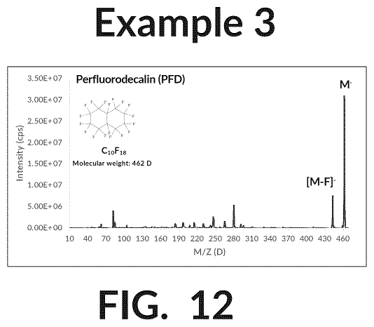

FIG. 12 shows a sample test result;

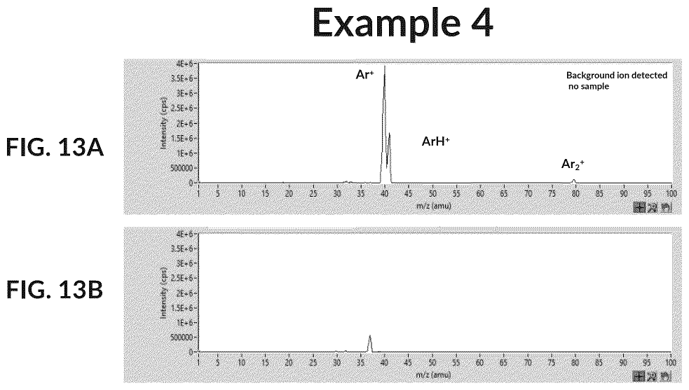

FIG. 13A shows a sample test result;

FIG. 13B shows a sample test result;

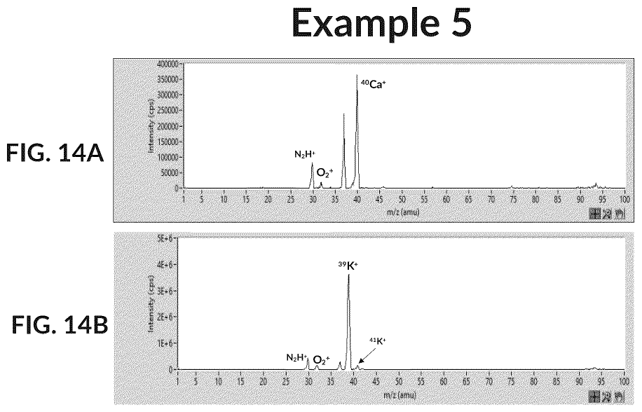

FIG. 14A shows a sample test result, and

FIG. 14B shows a sample test result.

### DETAILED DESCRIPTION OF THE INVENTION

FIG. 1 shows a schematics of an ICP-MS sampling interface and ICP source, comprising of a ICP torch 100 in a torch housing 101 that has an exhaust 102. In a conventional ICP-MS, the plasma 110 is placed in front of a sampler cone 112. The sample cone 112 has an orifice 115 that intakes the ions 116 generated by the plasma 110. The sampler cone is also mounted on a water-cooled body 120 to cool the sampler 112 and prevent the orifice, sealing mechanisms (i.e., O-rings and gaskets), or any other heat-sensitive components from thermal damage or melting due to the high temperature of the plasma. Typically, a roughing pump 125 is connected to the first vacuum stage 130 to create a typical pressure of a few Torrs behind the sampler. The ion sampling interface 120 is designed in a way to transfer the ions from sampler orifice to the mass analyzer(s) 199 (which resides in the highest vacuum stage) as fast as possible with minimal collisions with the background gas. This is to avoid any recombination, cluster formation, or neutralization of the ion species formed inside the plasma and transfer the elemental ions of interest to the mass analyzer(s) exactly as they are formed inside the plasma without any change. For this reason, the skimmer orifice 140 is typically placed right behind the sampler orifice 115 to skim and partially intake the emerging flow of gas and ions from the sampler orifice. The area behind the skimmer cone 145 (i.e., the 2^{nd} vacuum stage 150) that is mounted on a skimmer mount 152 is typically pumped by a turbomolecular pump 155 to further reduce the pressure and avoid recombination and neutralization of the ions. The optimum distance xₛ 160 between these two orifices is conventionally determined based on the position of the Mach disk x_{M} due to the supersonic free jet expansion behind the sampler orifice according to the following formula:

$${x}_{M} = 0.67 \times {D}_{0} \times \sqrt{( \frac{{P}_{0}}{{P}_{1}} )}$$

in which, D₀ is the diameter of the sampler orifice, P₀ is the pressure of the plasma (typically atmospheric), and P₁ is the pressure inside the first vacuum stage behind the sampler orifice. The skimmer orifice is typically placed before x_{M} (for example at 70% or ⅔^{rd} of X_{M}) to avoid the formation of a supersonic shock at or before the skimmer which will destroy and disperse the ion beam. On some occasions, additional skimmers (e.g., hyper-skimmers) and orifices are placed behind the primary skimmer cone to reduce the pressure from atmosphere to vacuum more gradually, while further diluting the stream of gas sampled from the plasma. The area(s) behind the additional skimmer(s) is typically evacuated by a turbomolecular pump. Following the skimmer cone(s), various ICP-MS systems employ extraction lenses, ion optics, ion guides, ion deflectors, photon stoppers, or other components to extract, focus, and form the ion beam and transfer it to the next stage of the MS system to be analyzed by the mass filter(s). These components may also serve to block photons and neutral species from reaching the later stages of the spectrometers, especially the ion detector. Also, the sampler and skimmer cones are designed in a way so that the vacuum pumps can remove the gas molecules as fast as possible to avoid any pressure build up or increase in the pressure of various vacuum stages which will cause ion scattering, recombination, and neutralization. All these arrangements in conventional ICP-MS are to ensure that the elemental ions of interest sampled from the plasma remain unmodified in order to increase the sensitivity and performance of the ICP-MS instruments for elemental analysis. Especially, the goal in conventional ICP-MS is to minimize the formation of any molecular species within various stages of the spectrometer as well as to keep oxide levels below 1-3%.

As mentioned above, ICP-MS relies on a high temperature inductively coupled plasma (ICP) source for production of high yields of atomic ions for elemental analysis. Atomization and ionization processes occur within the ICP source, leading to an abundance of atomic cations. The high-temperature plasma in the ICP-MS source is a result of inducing AC power into the plasma gas inside the ICP torch. The frequency of the power is typically in the radio-frequency range (e.g., 27.12 MHz or 40.68 MHZ), but microwave frequencies (e.g., 2.45 GHZ) has also been used. Argon (Ar) is the most common gas used for this purpose. Helium (He), nitrogen (N₂), air and other gases (monoatomic or diatomic) have also been used. Success of the ICP plasma source is in production of high yields of positive ions due to its high temperatures. For elemental analysis this is an ideal source for generating high yields of positive atomic ions of interest. But this source is not suitable for generating negative ions or for analysis of molecules. This in turn limits the applications of ICP-MS for obtaining a complete profile of the elemental and molecular species in a given sample.

When Ar is used as the plasma gas, undesirable ions and species such as Ar cation (Ar⁺), Argon neutral meta-stable (Ar*), and Argon meta-stable cation (Ar⁺*) together with diatomic and triatomic cations such as ArO⁺ and ArH⁺ are generated in high abundance (see FIG. 1). The presence of high yields of these species cause interference with the detection of ions of interest as well as limiting the ion transmission efficiency of the MS device, thereby limiting the appropriate detection of the desired ions. That is why conventional ICP-MS systems typically use a method or devices to block these species from reaching the later stages of the mass spectrometer and the ion detector. It is understood that in an ICP plasma source the net charge is zero (i.e., global charge neutrality). Therefore, there must be an equal number of negative species present relative to the positively charged species. While there may be some level of negative atomic and molecular species present in the plasma, it is the presence of a high number of free electrons (e⁻) in the plasma that is predominately responsible for maintaining the charge balance.

The plasma discharge inside the ICP torch with a buffer gas (M) of choice will produce positively and negatively charged ions. Mostly, noble gases are used as the buffer gas. Argon is the most popular gas while He and some other gases are also used in some cases. In both cases positively charged ions are far more abundant than negatively charged ones due to low electron affinity of the noble gases.

The present invention introduces a hybrid ICP-MS with a capability to perform both elemental and molecular analysis in various operation modes. The hybrid ICP-MS is equipped with technologies, devices, and techniques which utilize some of the species created by the plasma for creation of high yields of positively and negatively charged ions. There are two major advantages: firstly, the unwanted positive ions generated by the plasma are eliminated and prevented from entering the analyzing devices of the mass spectrometer. Additionally, their charge can be utilized to ionize the analytes of interest in “positive” mode through charge transfer ion/chemistry reactions. Secondly, the presence of excited neutral species (meta-stables) and free electrons can be an excellent source for generating negative ions of interest.

In the present invention, we introduce a new ICP-MS interface that enables the user to switch between multiple modes of operation on-demand for elemental analysis, molecular analysis, and elimination of background interferences for the first time. These new features provide the users with additional control over the operation of the system and open their hands for designing and developing new analytical methods with higher accuracy and selectivity that were not possible before. It also provides the ability to proceed with direct identification and quantification of molecules and compounds.

FIG. 2. shows a first embodiment of the present invention in which an insert 200 is implemented between the sampler 112 and skimmer orifices 140. The insert 200 can have a circular, square, asymmetric, or any arbitrary shape or form factor. The insert has at least one orifice 210 to allow the ions 216 to pass through toward the skimmer orifice. This will create a reaction chamber 220 between the sampler 112 and the insert 200 in which the pressure is higher than the pressure within the first stage 130 of the vacuum chamber pumped by the roughing pump 125. The reaction chamber is not directly pumped by any vacuum pump. Rather it is pumped through its orifice or orifices which will cause the pressure behind the sampler and inside the reaction chamber to be higher. Depending on the orifice sizes of the insert and the sampler and the pumping speed of the roughing pump, the pressure inside the reaction chamber may be between a few to tens of Torrs or a few hundred Torrs. For example, for a sampler orifice of around 1 mm using a vacuum pump with a pumping speed of 30-50 m³/hr, the pressure inside the reaction chamber may be between 20-200 Torrs for an insert orifice of 2-5 mm. This is higher than a typical 1 to 3 Torrs of pressure inside the first vacuum stage of a typical ICP-MS system. The geometries and form factors of the insert and the resulting reaction chamber are configured to provide the desired conditions. Depending on the pressure inside the reaction chamber, a supersonic free jet may be formed and issued from the back of the sampler orifice, which may reach the orifice of the insert. Therefore, preferably, the insert has a conical geometry to avoid the formation of normal shocks on its orifice (see FIG. 2). The angle of the cone is determined according to the Mach number of the free jet. For example, the cone angle may be between 20 to 80 degrees. The geometry of the insert may also be flat or it may have a concave form depending on the extent or existence of the supersonic expansion and the gas flow patterns within the reaction chamber. The concave form can also help with focusing the flow patterns toward the insert orifice and avoid any recirculation or dead zones inside reaction chamber, which may lead to memory effects or contamination. As another example, the geometry of the insert around the orifice area can be designed in a way to avoid disturbing the gas flow and ions traveling around the central axis between the sampler and skimmer cones. In this case, the edges of the insert orifice preferably are sharp to minimize the interaction of the ions with the insert orifice. Also using a smaller cone angle for the insert around the orifice is preferred to minimize the formation of normal or bow shocks on the orifice. For example, the cone angle can be between 40-60 degrees or less.

Due to the higher pressure of the reaction chamber, the ions and other species sampled from the plasma may be modified by going through various reactions. By providing a higher pressure at appropriate levels inside the reaction chamber, the mean free path would be short enough for any given ion/molecular reaction to fully proceed. Introduction of analytes into the reaction chamber, directly or through any heated spray chamber, evaporator, thermal desorption devices or other sample introduction methods (depending on the sample type), allows for the analytes to react via gas-phase ion chemistry and be ionized in both negatively-and positively-charged states. In this case, the plasma power may be significantly reduced (for example to 300-500 W) so that the plasma can be used to desolvate the sample instead of full decomposition. In case the user prefers to perform elemental analysis similar to conventional ICP-MS systems, the insert can be removed or the pressure inside the reaction chamber can be modified as described below. Therefore, the user can choose between various modes of operation for both elemental and molecular analyses. These are unique aspects of the present invention.

The insert may be mounted on the body of the interface beneath the sampler cone. A threaded insert may be used for this purpose to secure the insert in place. Alternatively, the insert may be attached to the interface using screws. A quick-connect feature may be implemented in the insert design to be able to quickly assemble or remove the insert from its place without using any screws or fasteners. Sealing components such as O-rings, gaskets, or washers may be used to properly seal the area within the reaction chamber from the first vacuum stage or the atmosphere to be able to pressurize the reaction chamber more reliably. When rubber O-rings are used, the temperature of the interface and insert should be preferably kept below 100 C to avoid damaging the O-rings. For this purpose, the interface may be water-cooled or air-cooled to improve the rate of heat transfer. Alternatively, metal or graphite gaskets can be used for this purpose which can tolerate much higher temperatures. Roughness of the sealing surfaces should be kept below 1.6 μm, more preferably 0.8 μm. Considering the smaller ratio of the pressures inside the reaction chamber and the first stage of the mass spectrometer (as compared to the ratio of the atmospheric pressure to the first vacuum stage), sealing components may not be necessary between the insert and the interface body.

To avoid overheating the insert with possible oxidation, melting, or thermal damage consequences, the insert may be made of materials with high thermal conductivity, high melting point, and good to excellent resistance against corrosion and oxidation. Some examples are aluminum, nickel, copper, stainless steel, molybdenum, brass, and their various alloys or compositions. The surface of the insert can be plated with gold, silver, or platinum to increase corrosion resistance and inhibit oxidation, or coated with ceramics or thermal barrier coatings such as aluminum oxide, yttria stabilized zirconia, yttrium oxide, or a combination of these materials. Ceramics such as aluminum oxide, boron nitride, and silicon nitride may be used for the insert which have relatively high thermal conductivity, very high melting points, excellent resistance to corrosion, and good thermal shock characteristics. In some cases, it would be beneficial to keep the temperature of the insert and reaction chamber walls as high as possible (as much as allowed by the properties of materials used for these components and as long as it does not cause thermal damage, oxidation, or corrosion) to avoid deposition and memory effects. This can be accomplished by limiting the rate of heat transfer from these components to the surrounding to keep the heat absorbed from the plasma by these components within them as much as possible.

In general, the insert may be electrically grounded through the interface body. But the insert may also be electrically isolated from the interface by using some ceramic or plastic spacers between the insert and the interface body. A positive or negative voltage may be applied to the insert in this case to focus the ions exiting the insert as they travel toward the skimmer orifice and to extract the ions emerging from the sampler orifice to improve ion transmission.

Alternatively, the insert may be mounted, assembled, or screwed onto the sampler cone to form a reaction chamber together with the sampler cone. In this manner, both the insert and sampler cone can be accessed and removed more conveniently for cleaning, maintenance, and service purposes.

FIG. 3 shows a second embodiment of the present invention in which a channel 300 is implemented within the interface body 320 to be able to introduce gases, reagents, dopants, or samples (i.e., analytes) 340 of interest into the reaction chamber. Part of this channel may be implemented in the sampler cone or the insert. For example, the gases, reagents, dopants or samples may be introduced to the reaction chamber through a hole implemented in the interface body. These gases can then directly enter the reaction chamber or go through a set of one or more holes and channels inside the sampler cone or the insert before entering the reaction chamber. The plasma heat absorbed by the sampler cone or the insert or the interface body can be used to make sure no condensation happens withing the gases, reagents, dopants, or samples introduced to the reaction chamber as they travel through the channel. The heat may also be used to evaporate or desolvate any liquid or non-vaporized material inside the channel. This heat can also help with keeping the channel and the sampler cone and the insert clean by evaporating and degassing any material deposited on their surfaces, thereby offering a self-cleaning interface and reaction chamber to minimize memory effects and contamination issues.

The flow rate of the gases introduced into the reaction chamber can be controlled accurately using mass flow controllers, precise valves, or pressure controllers. To minimize sample or reagent loss inside the reaction chamber, the channel mentioned above may be designed in a way to introduce the sample or reagents right in front of the insert orifice. Also, for better mixing of all the gas species and improve homogeneity and reaction rates inside the reaction chamber, a swirling flow pattern may be induced inside the reaction chamber by introducing the gases or samples tangentially through one or a set of holes distributed around the reaction chamber. This will improve mixing of the gases and ions coming from the plasma with the materials introduced through the channel into the reaction chamber.

In this case, the pressure and temperature of the reaction chamber can be further controlled and adjusted by introducing various gases or samples into it while controlling the flow rate. This will create a situation inside the reaction chamber that is suitable for soft ionization of samples. In exothermic reactions, ionization energy of an analyte (An) introduced into the reaction chamber must be less than that of the buffer gas M (for example argon), so that charge transfer reaction can proceed with an energy release (exothermic reaction). The amount of the energy released is proportional to the difference between ionization energy of the reactant partners and is normally dissipated in the entire structure of the analyte molecule. Small amount of dissipated energy is very unlikely to be strong enough to break any bonds of the charged analyte. In some cases, the structure of positively charged or negatively charged analyte is not stable; therefore, it fragments spontaneously.

In most cases when Ar is used as a buffer gas, presence of Ar⁺, ArO⁺, ArH⁺ and Ar₂⁺ are highly dominant in the mass spectra. Also, presence of Ar⁺ and free electrons (e⁻) are evident from the glow discharge resulted from these species inside the mass spectrometer. Note that any other buffer gases, whether monoatomic or diatomic, can be used in this manner and will lead to various ionic, neutral, and metastable species that can be used inside the reaction chamber. Herein, we are utilizing positively charged Ar species within the reaction chamber to proceed with ionization of the analyte of interest through soft charge transfer for creation of high yields of intact analyte molecular ions of interest. This novel technique allows for unprecedented formation of high yields of molecular ions in their intact form that other ICP-MS systems are not capable of. The following reaction can be considered in this case:

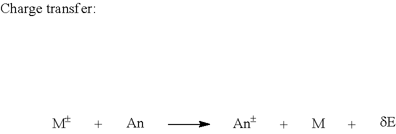

In the presence of the analyte inside the reaction chamber, it is expected for positive charge transfer from buffer ion (M⁺) to the analyte to be more dominant compared to M.

Free electrons are understood to be the most abundant charged species within the hot plasma source. Many research studies point to the fact that the energy of these electrons are less than 10 eV, more commonly around 1 eV. Therefore, it makes them suitable for attaching to any molecules or atoms with negative electron affinity. Electron attachment reactions normally proceed rapidly with high reaction cross-sections. Within the described reaction chamber, the presence of free electrons and analyte atoms or molecules allows for electron attachment to proceed with high efficiency. Energy dissipated from these reactions are minute. Therefore, it is highly unlikely to cause any fragmentation.

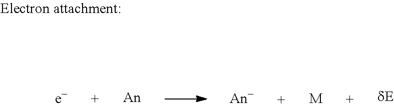

Additionally, as a result of the plasma discharge within the ICP torch, meta-stable species form as evident from the glow discharge behind the sampler interface and at different points within the mass spectrometer. The most controlled ionization process is known to be Penning ionization in which the energy of the meta-stable is transferred to the reactant partner. If ionization energy of the reactant partner is less than the excited energy of the meta-stable species, all this energy will transfer to the reactant partner and result in ionization of the reactant molecules with high efficiency (Penning ionization) plus a free electrons. This is a selective ionization process since the meta-stable states are well understood and energy of the excited states are well categorized together with ionization energy of the reactant. Hence an appropriate reaction can be designed for Penning ionization to proceed with high selectivity. In these types of exothermic reactions, the amount of the energy dissipation is simply equal to the difference between the energy of the excited electron (meta-stable energy level) and ionization energy of the reactant molecules. This is not a significant amount to cause fragmentation. Hence, the intact molecules of interest can be ionized in high abundance which with significant implication, specifically in quantitative analyses.

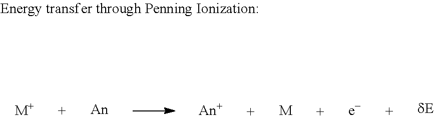

The free electrons generated by the above reaction can also be utilized via electron attachment reaction for formation of intact negatively charged ions:

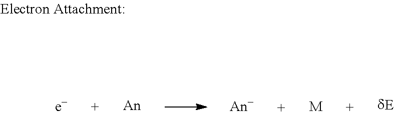

FIG. 4A shows another embodiment of the present invention. In this case, holes 420 or openings in addition to the central orifice 410 are implemented in the insert 400 as demonstrated in FIG. 4B which shows a top view of one example of the insert design. These holes can have an arbitrary shape and form factor. For example, they can be circular, arc slots, and annular opening, symmetrically or asymmetrically distributed around the center. The number and area of these holes and openings are adjusted in a way to achieve the desirable pressure level inside the reaction chamber for elemental and molecular analysis. As a result, the pressure inside the reaction chamber can be equivalent or slightly higher than the pressure of the first stage if no analyte, gas, reagent or dopant is introduced into the reaction chamber. In this manner, the ion bean 416 mainly comprises of elemental ions formed inside the plasma that can pass through the reaction chamber without significant collisions or recombination. This mode of operation would be similar to a conventional ICP-MS system in which the level of oxides (typically characterized based on the ratio of cerium oxide ions to cerium ions) can be maintained below 1-3% as a common practice in this field. It is important in this case to keep the distance between the sampler and skimmer orifices according to the formula provided above within x_{M}. As a result, by adjusting the pressure inside the reaction chamber through introduction and tuning of a gas flow into the reaction chamber, the user would be able to quickly switch between elemental analysis and molecular analysis modes, thereby offering the first ever hybrid ICP-MS.

FIGS. 5A and 5B show another embodiment of the present invention in which a rotatable disk 530 is implemented within the interface. The rotatable disk has one or several openings. When the openings of the rotable disk are aligned 532 with the holes or openings of the insert 500, the reaction chamber 520 will not be pressurized, thereby offering elemental analysis mode (FIG. 5B). When the openings are not aligned 531, the reaction chamber will be pressurized which will lead to modification of the ion beam or creation of new analyte ions (molecular, positive or negative molecular or elemental ions) through gas phase reaction described above (FIG. 5A). The rotatable disk may be moved using a motor, actuator, pneumatically, manually, or via any other methods to switch between various modes of analysis. For example, an electrical servo motor may be implemented in the interface which can rotate the rotatable disk through a set of gears. In another case, the rotatable disk may be connected to a handle that extends beyond the interface and is accessible outside the vacuum chamber. Therefore, the handle can be either moved to rotate the disk manually, or through a linear pneumatic actuator. Sealing components such as O-rings, gaskets, or washers may be used between the rotating disk, the interface body, and the insert to seal the space within the reaction chamber from the first stage of the mass spectrometer to be able to retain the gas and analytes withing the reaction chamber at the desired pressure levels. It may be more convenient from a sealing point of view to implement the mechanism used for rotating the disk inside the vacuum chamber. Otherwise, additional sealing components will be necessary to avoid atmospheric air leakage from outside the vacuum chamber.

FIGS. 6A and 6B show another embodiment of the present invention. In this case, instead of implementing an insert to form the reaction chamber, a slider gate 600 with an orifice 620 is implemented which can be actuated and moved manually or automatically to slide between the sampler and skimmer orifices to create the reaction chamber 630 (FIG. 6A), or remove the slider gate 621 to prevent formation of a reaction chamber 640. Sealing components such as O-rings, gaskets, or washers are used to prevent and control gas leakage between the reaction chamber, first stage of the spectrometer, and the atmosphere. The gate may be moved through electronic or pneumatic means or by hand for this purpose. Therefore, the user will again be able to switch between conventional ICP-MS elemental analysis mode and molecular analysis mode on demand. The orifice of the gate allows for the product ions inside the reaction chamber to be able to reach the skimmer orifice. The distance between the sampler and skimmer orifices are similarly determined based on the position of the Mach disk x_{M} (as provided by the formula above) to ensure optimal operation during elemental analysis mode.

FIG. 7 shows another embodiment of the present invention in which a circular gate 700 is implemented instead of an insert or a sliding gate. The circular gate may have one or several radial holes (not shown) to achieve the desirable pressure levels inside the reaction chamber 720 and avoid over-pressurizing the vacuum stage behind the skimmer orifice by pushing excessive gas through the skimmer orifice. For example, the circular gate may be comprised of two cylindrical parts. Each of the two parts can have one or several holes or openings distributed radially around their central axis. One of the parts can be stationary while the other one can rotate with respect to the stationary part using a mechanism. Similar to the design shown in FIGS. 5A and 5B, when the moving part rotates, its holes or openings can align with the holes and openings of the stationary part to depressurize the reaction chamber. Otherwise, if the moving part completely or partially covers and blocks the holes and openings of the stationary part, the reaction chamber will be pressurized. In this manner, for elemental analysis operation mode, the gate may be opened to let the vacuum pump fully evacuate the first vacuum stage behind the sampler orifice and reach a few Torrs which is common in conventional ICP-MS.

FIG. 8 shows another embodiment of the present invention in which the new interface has an air cooling system 800 for air cooling, instead of water cooling as common in conventional ICP-MS.

For ease of maintenance and service, a gate valve may be implemented in the interface after the skimmer cone to be able to access the sampler cone, insert, and the skimmer cone without needing to break the vacuum. In this manner, the gate valve may be closed to retain the vacuum beyond the skimmer and avoid any issues for the vacuum pumps (i.e., roughing pumps and turbomolecular pumps) due to the high pressures or unnecessarily exposing the sensitive components inside the mass spectrometer to atmospheric air and contamination when servicing the interface. Once the gate is closed, the sampler cone, insert, and the skimmer cone may be conveniently removed for cleaning purposes or replacement. This will also reduce the downtime of the instrument.

In all these embodiments, the analytes may be introduced to the ICP-MS system using several sample introduction systems (depending on the sample type and desired mode of analysis) either through the injector tube of the ICP torch or through the channel implemented in the interface for the reaction chamber. In the case of elemental analysis, it is typically desirable to run the plasma at higher powers (for example between 700-1600 W) to fully decompose the sample and ionize the elements and avoid higher levels of oxides and molecular species. In this case the sample can be introduced through the ICP torch. For soft ionization of molecular samples, the sample can be introduced to the ICP-MS system through the plasma torch with lower power (e.g., 300-500 W) or higher-than-optimum carrier gas flow rate to avoid decomposing the molecules of interest by offering a colder plasma. In this manner, the plasma will generally act as an evaporator, desolvator, or thermal desorption system and the soft ionization process will mainly happen inside the reaction chamber.

Alternatively, it may be more desirable to introduce the sample in gaseous, solid (for example a fine solid aerosol), or liquid form (for example nano-or micro-spray or a fine aerosol) into the reaction chamber directly. This will provide a more efficient and less aggressive situation for soft ionization of fragile molecules. FIG. 9 shows an embodiment of the present invention in which the sample is introduced into the reaction chamber through micro-or nano-spray 900. In this case, the temperature inside the reaction chamber is high enough to desolvate, evaporate, or thermally desorb the spray. On other occasions, the sample may be introduced through electrospray ionization (ESI), or from a gas chromatograph (GC), or a liquid chromatograph (LC), laser ablation system (LA), or any other sample introduction methods either through the ICP torch, via a channel into the reaction chamber, or directly to the reaction chamber.

Following the skimmer orifice, the mass spectrometer may have various components and electrical devices to extract, form, and focus the ion beam emerging from the skimmer orifice. For example, one or several RF-only ion guides combined with ion lenses may be used after the skimmer for this purpose. Alternatively, one or several ion lenses can be used to focus the ion beam and transfer it to the mass analyzer. To block any photons or neutral species from reaching the later stages of the mass spectrometer, ion deflectors or photon stoppers may be used after the skimmer. For analyzing the ions, the mass spectrometer may have a single quadrupole, triple quadrupole, sector field, ion mobility, ion trap, Fourier-transform ion cyclotron resonance mass spectrometer, or time-of-flight architecture. In any case, due to the unique capabilities of the present invention in generating both positive and negative ions, the hybrid ICP-MS system can analyze ions in both positive and negative modes. Similarly, the ion detector is equipped with dual polarity capabilities to detect both positive and negative ions. For this purpose, various ion detector types may be used such as continuous dynode, discrete dynode, Faraday cup, multichannel plate detector (MCP), dual mode detectors, avalanche dynode, etc. This is unprecedented in this field, as conventional ICP-MS systems are only capable of and configured for analyzing positive ions. It should be mentioned that instead of using the reaction chamber, the analyte can be introduced into any other regions of the mass spectrometer that allows for ion chemistry to proceed (e.g., ion guides, collision/reaction cells, etc.) using the ionic and meta-stable species and electrons generated by the plasma or the reaction chamber as described above.

Another capability of the hybrid ICP-MS system is that it can eliminate background interferences from argon species. As mentioned above, argon (Ar) is the most common gas used in ICP-MS. As a result, a high abundance of Ar cation (Ar⁺), Argon neutral meta-stable (Ar*), Argon meta-stable cation (Ar*⁺) and other argon diatomic and triatomic cations such as ArO⁺ and ArH⁺ are generated. These species have a number of negative consequences for detection of some elemental ions of interest. For example: Potassium (³⁹K) and Calcium (⁴⁰Ca) are very important elements in many scientific disciplines. But the presence of ³⁸ArH⁺ (39) and ⁴⁰Ar⁺ (40) in such high abundances overshadows proper detection of these atoms of interest. Isotope ⁴¹Ca is highly important in medical diagnostics. Detection of ⁴¹Ca⁺ in a pure form is of great interest. But the presence of ⁴⁰ArH⁺ hinders the detection of this isotope even with high resolution devices. Another isobaric interference is of ⁴⁰ArO⁺ (56) with Iron's main isotope (⁵⁶Fe+).

Some of the most troublesome interferents originate from the argon ICP source, generating an abundance of argon ions and molecular species. The most important elements that experience isobaric and polyatomic interference from plasma gas species include iron (Fe), calcium (Ca), potassium (K), and selenium (Se).

Calcium is the third most abundant metal and the fifth most abundant element in Earth's crust. It has many different applications, making accurate analysis of Calcium in trace and ultra-trace levels important. While ICP-MS is the most powerful technique for elemental analysis, the most abundant isotope of Calcium, ⁴⁰Ca, is completely obscured by ⁴⁰Ar which constitutes the plasma gas. As a result, accurate and sensitive detection and isotopic analysis of Calcium with ICP-MS is associated with major challenges.

Potassium has applications in various fields such as agricultural, medical, food industry, etc. Potassium isotopes such as ⁴¹K also have some novel applications in drug synthesis, life sciences, and biology. Analysing potassium at ppb-ppt levels as contamination on/in semiconductor parts and surfaces are also of importance. Mining potash has significant environmental impacts which necessitates monitoring and tracing potash levels (through analysis of natural potassium radionuclides, e.g. ⁴⁰K) in the environment, in mining trails, abandoned mines, and as part of water treatment plans of mining companies. These applications underline the importance of accurate potassium measurement and speciation in various samples. Similar to Calcium, ⁴⁰Ar ions interfere with the most abundant isotope of potassium, ³⁹K, due to the very large number of argon ions generated from the plasma that cause the tail of the ⁴⁰Ar peak to contribute to ³⁹K peak on the mass spectrum and result in low accuracy when analyzing this element. ³⁸ArH species also interferes with ³⁹K. Potassium's other isotope, ⁴¹K, is also obscured by ⁴⁰ArH species.

For iron, the most abundant isotope is ⁵⁶Fe which has the same mass as ⁴⁰Ar¹⁶O species that comes from the plasma. It is evident that iron has many applications in various industries and is widely used for steel production, manufacturing, automotive industry and transportation, civil engineering and construction, etc. In the body, iron is responsible for transport, supply, and storage of oxygen as well as helping with metabolism, immune system, and cognitive function. Due to the interference of argon oxide with ⁵⁶Fe in ICP-MS, analysis of iron is associated with difficulties and requires complicated procedures and instrumentation.

Selenium (Se) is another element for which the most abundant isotope, ⁸⁰Se, is obscured with ⁴⁰Ar⁴⁰Ar from the plasma. Selenium is a semiconductor that is widely used in the electronic industry in photovoltaic cells, light sensing, photocopiers, power supplies, etc. Selenium is also a biologically essential trace element. But excess amounts of selenium (>400-800 μg/day) can cause toxicity. Selenium proteins and enzymes are involved in anti-oxidative activity and prevent oxidative damage to DNA which can help in the prevention of cancer and other diseases. As a result, selenium has been widely used as a tag to facilitate the recognition and determination of Se-containing species in complex sample mixtures.

Another important element that suffers from interference with argon species is arsenic (As). Analyzing arsenic using ICP-MS holds paramount importance due to the toxic nature of arsenic and its potential impact on both human health and the environment. Arsenic contamination in water sources, soil, and food poses significant risks, as prolonged exposure can lead to severe health issues, including cancers, skin lesions, and cardiovascular diseases. However, analysis of arsenic (⁷⁵As⁺) with ICP-MS is associated with difficulties due to the high ionization energy of arsenic as well as polyatomic interference from ⁴⁰Ar³⁵Cl⁺ molecules.

In addition to these interferences, there are other negative effects caused by the presence of these species. For example, potential well depth of ion guides reaches the space charge limit when occupied by these unwanted species, thereby limiting the transmission of elements of interest and reducing the sensitivity of the MS device. Furthermore, the presence of neutral Ar* is known to limit the performance of the MS device.

The hybrid ICP-MS system of the present invention has the capability to completely eliminate the above-mentioned Ar interferences by introducing suitable reagents or dopants into the reaction chamber which can react with Ar species through various mechanisms and neutralize them. In the following sections, examples of new methods of using the hybrid ICP-MS system are provided that shows its capabilities in analyzing both elemental and molecular samples in positive and negative modes, as well as the ability to completely remove argon interferences from the mass spectrum.

### Example 1 of Using the Hybrid ICP-MS for Molecular Analysis With Soft Ionization

FIG. 10A illustrate the background mass spectra using Ar as a buffer gas. Presence of Ar⁺ and ArH⁺ are shown. There is also presence of Ar dimmer ion (Ar²⁺) which is a typical background from ICP plasma source. Also, argon meta-stable neutral (Ar⁺) is normally present in high abundance together with free electrons.

A small amount of Acetone vapor was then introduced into the reaction chamber through the introduction channel. FIG. 10B illustrates the mass spectra of the protonated Acetone ion and protonated Acetone dimmer. Acetone dimmer ion formation is a result of the secondary reaction of protonated Acetone with Acetone neutral molecule (see FIG. 10C). The mechanism of formation of protonated Acetone dimmer is believed to be due to formation of a protonated bridge between the molecules as shown below. These types of molecules are considered to be very fragile and require very little energy to fragment. The presence of high counts of protonated Acetone dimmer is a clear indication to the fact that soft ionization is happening within the reaction chamber. It is worth noting that all the associated ions with argon contribute to this process by offering their charge through ion/molecular reaction to form Acetone ions. This also has significant importance in eliminating the unwanted background Ar ions in normal operation of the ICP-MS. The technique to form molecular ions in ICP-MS through soft ionization without fragmenting them is a novel aspect of the present invention.

This process can also happen inside other stages of the mass spectrometer in which ion chemistry is allowed to proceed (e.g., ion guides, collision/reaction cells, etc.) using the ionic and meta-stable species and electrons generated by the plasma or the reaction chamber as described above.

### Example 2 of Using the hybrid ICP-MS for Molecular Analysis With Soft Ionization

FIG. 11 shows the formation of intact positive molecular ions by charge transfer reaction from buffer ions to the analyte (in this case perfluorodecalin, PFD) inside the reaction chamber. The energy of the neutral meta-stable molecules is yet another viable source for generation of intact positive ions through penning ionization. In this example, the intact molecule of interest is largely detectable alongside some fragments.

In GC-MS, electron impact ionization (EI) sources are commonly used to generate ions. For creating positive ions, the energy of electron impact beam is sustained at more than 70 eV for higher ionization efficiency. This amount of energy is normally dissipating in the entire structure of the molecule and in many cases results in fragmentation of the molecule of the interest. In the case of PFD, the intact molecular ion is not typically detected in GC-MS due to sever fragmentation. This example clearly demonstrates the capabilities of the hybrid ICP-MS system for generating intact molecular ions and can open doors to new applications.

### Example 3 of Using the Hybrid ICP-MS for Molecular Analysis With Soft Ionization in Negative Mode

FIG. 12 shows the formation of intact negative molecular ions from PFD when introduced into the reaction chamber in the hybrid ICP-MS system. The formation of intact negative ions are due to low energy free electrons created directly from the plasma discharge with the buffer gas (here argon) which are susceptible to attachment to the analyte molecules via electron attachment. Another possible path for electron attachment can be correlated to free electrons generated from the neutral meta-stable species in reaction with the analyte. Both of these two sources of free electrons are considered to be viable for formation of intact negative ions.

### Example 4 of Using the Hybrid ICP-MS for Removal of Argon Interferences for Elemental Analysis

There have been many attempts to reduce if not eliminate the unwanted species created by the ICP source before they reach the MS device. Especially, argon species that interfere with accurate determination of elements such as Ca, K, Se, As, and Fe have been the subject of many studies and complicated method developments. Herein, we are disclosing a novel technique that allows a suitable dopant to be injected into the reaction chamber to completely neutralize and eliminate Argon cation and its cluster ions including argon meta-stable neutrals.

Ar has a doublet ground state (²P_{1/2}, ²P_{3/2}) with 0.2 eV energy difference. The ionization energy for both states are 15.4 and 15.6 eV respectively. After He, Ne, and F it has the highest ionization energy. Therefore, in reaction with any dopant, charge transfer is probable.

Meta-stable energy state of Ar has a long lifetime (t_{1/2}=45 s) and both spin states have energies of 11.4 and 11.6 eV respectively. Through the Penning ionization process, any reagent with ionization energy less than this energy readily ionizes by Ar*. Reaction of Ar* with reagents having higher ionization energy than meta-stable argon will likely share the electronic excited state energy; therefore, Ar most likely losses some of its energy and the excited electron occupies lower energy level which are normally short-lived states. It either decays spontaneously to a lower energy state or it loses more energy with subsequent collisions.

ArO⁺ seems to have an ionization energy higher than Methane (CH₄) [IE=12.6 eV] since reaction of these two species proceed via charge transfer reaction very efficiently. On the other hand, oxygen affinity of Ar is low and oxygen ion transfer is a favourable channel of reaction as well. This is very evident in reaction of this ion with CO, N₂.

ArH⁺ is formed in high abundance from the plasma source. Considering that proton affinity of Ar is very low (≈369.2 KJ/mol), it is susceptible to proton transfer to any reagent with higher proton affinity (which includes most, if is not all the reagents). This is quite evident in the reactions reported here For example, proton affinity of some reagents are as follows: PA(N₂)=493.8 KJ/mol; PA(CO)=426.2 KJ/mol; PA(CO₂)=540.5 KJ/mol; PA(CH₄)=543.5 KJ/mol. Note that the proton transfer reactions are generally short range. This means that if the proton transfer reaction is exothermic, reaction will proceed with high reaction cross section.

Ar₂⁺ transfers charge highly efficiently to so many reagents including N₂, O₂, Kr, Xe, CO, CO₂, NO, NO₂, N₂O, CS₂, SO₂, and SF₆ as observed experimentally by a number of different methods. This might be due to a high ionization energy of this ion which has been reported to be 14.5-15.0 eV.

Here are some chemical reaction mechanisms for elimination of Ar⁺, Aro⁺, ArH⁺, Ar₂⁺ and Ar* With N₂:

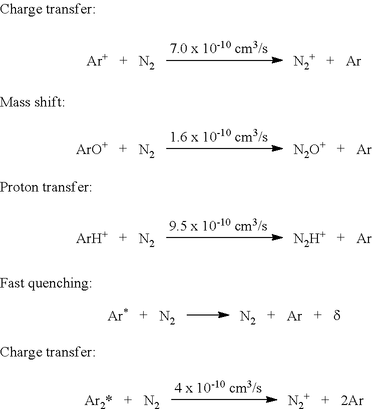

FIG. 13A shows the background ions generated by the argon ICP source. Ar⁺ and ArH⁺ are clearly visible in high abundance. Ar₂⁺ is also clearly visible. We do not observe ArO⁺ in this example.

FIG. 13B illustrates the spectra when N₂ has been injected into the reaction chamber. We can clearly see the destruction of Ar ion and its associated species. Mass 37 seems to be a contamination that appears when N₂ is injected.

Here are additional examples for ion chemistry mechanisms for elimination of Ar+, ArO+, ArH+and Ar*:

### In Reaction With CO

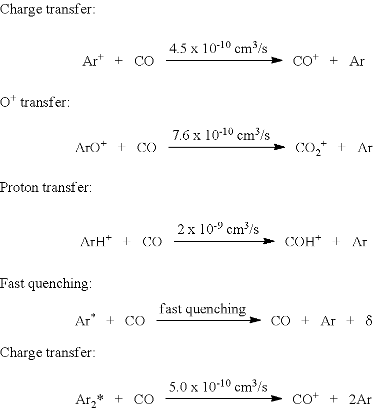

### In Reaction With CO₂

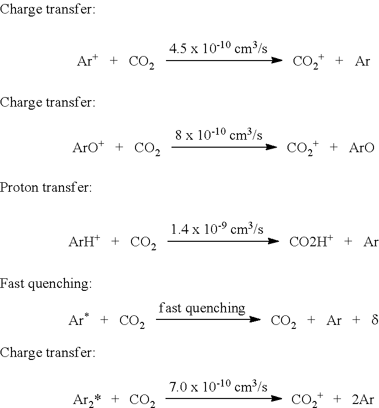

### In Reaction With CH₄

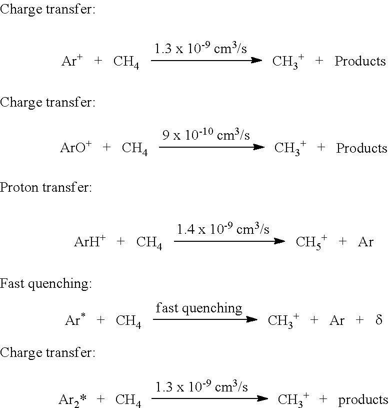

### Example 5 of Using the Hybrid ICP-MS for Interference-Free Analysis of Calcium and Potassium

It is understood that chemistry is driven entirely by virtue of electron interaction while radioactivity is purely due to nuclei interaction and has no contribution towards chemical kinetics. Therefore, it can be concluded that ion chemistry of the radioactive isotopes would proceed similar to that of the stable isotopes. Mass spectrometers with the ability of detecting radioisotopes in pure form at very low concentrations will have a great impact on our understanding in many scientific fields. A low level of radioisotopes may serve as good candidates for isotope labeling in living tissues while minimizing the effect of chemical and radioactive toxicity. For this purpose, it is preferred that the elements of choice are already a part of living anatomy (e.g., C, N, O, H, Ca, K, Na, P, Cl, Fe, Zn, Co, I, Se, V, etc.) so that they do not cause significant adverse effects via chemical reactivity. In this manner, the presence of rare radio-isotopes of the existing elements in living tissues will be unique and easily traceable. There are two major groups of radioisotopes used for this purpose: stable trace isotopes (minimal population) or short-lived synthesized radioactive isotopes. The presence of both isotopes would be unique in living tissues and easily detectable by mass spectrometers.

Normally, stable trace isotopes will have a long lifetime. They decay radioactively to other elements that are relatively long-lived. On the other hand, short-lived synthesized radioisotopes with half-lives of a few hours or days might cause interference issues when they decay to other element. Here, we disclose a method using the hybrid ICP-MS system to eliminate this problem.

Calcium (Ca) and potassium (K) are two major elements in living organism. Ca is one of the most abundant elements in human body and plays a major rule in formation of bone and teeth, controlling muscle growth and maintaining the blood pressure. Monitoring the Ca atom is highly valued in diagnostic medicine. It is, therefore, apparent that detection of Ca atom in pure form can be highly important for maintaining and monitoring human health. Potassium is another important element in human body.

Here we introduce a method for analysis of calcium and potassium isotopes based on their most abundant isotopes without any interference using the hybrid ICP-MS. This has been a challenge for traditional platforms because of creation of a high abundance of ⁴⁰Ar⁺ and ³⁸ArH⁺ by the ICP source. The presence of these unwanted ions prevents accurate and convenient detection of ⁴⁰Ca and ³⁹K isotopes and leads to higher-than-average detection limits for these elements compared to the other elements in the periodic table.

FIG. 14A and FIG. 14B illustrate unprecedented detection of ⁴⁰Ca and ³⁹K on their original mass in addition to their corresponding isotopes when 0.1 μg/mL of this compound was injected into the ICP source while nitrogen was being introduced into the reaction chamber to eliminate the argon ion species with a flow rate of between 0.1-2 L/min. The pressure inside the reaction chamber was also between 20-200 Torrs. Detection of these ions on their original mass has been one of the greatest challenges for traditional ICP-MS devices where the presence of Ar⁺ and its associated species overlap with detection of these ions, therefore making it almost impossible to detect these elements of high interest in a pure form without any special arrangements or complicated devices in the mass spectrometer.

### Example 6 of Using the Hybrid ICP-MS for Interference-Free Analysis of Various Isotopes of Calcium and Potassium

Here are some other reaction mechanisms using the hybrid ICP-MS system through which interferences can be removed or avoided so that other calcium and potassium isotopes can be analyzed with high accuracy. These reactions are possible by introducing various reagents upstream of a mass spectrometer (i.e., mass analyzers) where pressure is high enough for these ion-chemistry reactions to proceed effectively. This is another unique aspect of the present hybrid ICP-MS in contrast to the existing tandem ICP-MS systems with collision/reaction cells. At the same time, the reagents can also be introduced in the collision cell of a tandem mass spectrometer possibly together with a collision gas.

⁴¹Ca is a trace isotope of Ca with a half-life of (t_{1/2}=10⁵ y). This element can act as a candidate for isotope labeling. This isotope decays through electron capture (ε⁻) into ⁴¹K. Although there is no Ar in living tissues, the presence of ⁴⁰ArH⁺, ⁴¹Ar⁺ and ⁴¹K (with a 6.7% abundance and presence in living tissues) in ICP-MS creates interference with detection of ⁴¹Ca. Here we introduce a number of methods that ⁴¹Ca⁺ can be detected without interference by eliminating the mentioned isotopes via ion chemistry using the reaction chamber.

Analysis of ⁴¹Ca Through Reaction With SF₆ to Avoid Interference From ⁴¹K

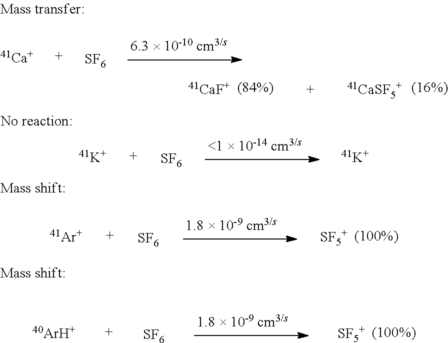

Analysis of ⁴¹Ca Through Reaction With NO₂ to Avoid Interference From ⁴¹K

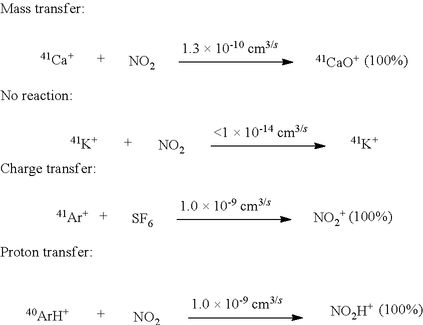

In addition, ⁴⁵Ca and ⁴⁷Ca are synthetic isotopes of Ca that have important applications in nuclear medicine. Both isotopes decay to ⁴⁵Sc & ⁴⁷Sc by β⁻ emission with ½-life of 162.6 and 4.5 days respectively. It is therefore highly desirable to produce a scheme in order to distinguish between these two Ca isotopes and the isotopes that they decay to (i.e., Sc isotopes).

### Analysis of Ca Through Reaction With NH₃

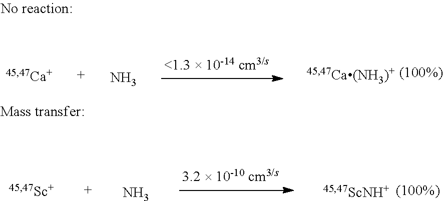

### Analysis of Ca Through Reaction With D₂O

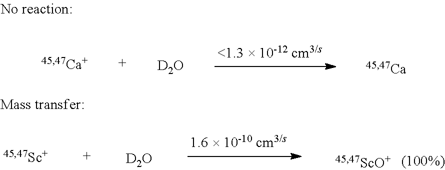

In conclusion, the two elements, Ca and K, can be detected by the hybrid ICP-MS mass spectrometer in a pure form offering a great enhancement in nuclear diagnostic medicine.

As another example, ⁴⁰K is a rare isotope of ³⁹K which can serve as an ideal candidate for isotope labeling with a half-life of t_{1/2}=1.2×10⁹ y which decays into ⁴⁰Ar by electron capture.

### Reaction With SF₆

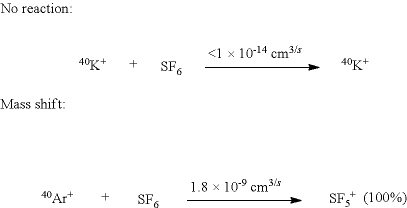

### Reaction With NO₂

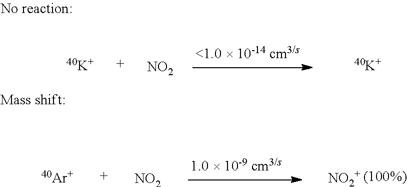

1) A hybrid inductively coupled plasma mass spectrometer (ICP-MS) system to perform both elemental and molecular analysis in both positive and negative polarities, the system comprising:
a) an inductively coupled plasma (ICP) source having at least one inlet to receive a background gas and analytes, and to at least partially ionize the background gas and generate a plasma and plasma species comprising of ions that comprise of positive and negative ions, meta-stable ions and neutrals, and molecules of the background gas, and free electrons;
b) a mass spectrometer (MS)
c) an interface having an interface body and a sampler cone that has a sampler orifice and is placed in front of the plasma to intake ions and plasma species;
d) a first vacuum stage behind the sampler cone to create a first vacuum stage pressure of a few Torrs behind the sampler cone using a first pump with a pumping speed;
e) a skimmer placed at a predefined distance behind the sampler orifice, wherein the skimmer has a central orifice to skim and partially intake the emerging flow of plasma species from the sampler orifice;
f) a second vacuum stage behind the skimmer cone to create a second vacuum stage pressure behind the skimmer using a second pump to further reduce the pressure and avoid recombination and neutralization of the ions;
g) an insert having an insert orifice, a geometry, and a form factor, placed between the sampler cone and the skimmer, wherein the insert orifice allows plasma species to pass through toward the skimmer orifice;
wherein the insert is configured to create a reaction chamber (zone) between the sampler cone and the insert, wherein the reaction chamber pressure and its temperature are controlled by the insert orifice size and form factor, the sampler orifice size and the pumping speed of the first pump, allowing the reaction chamber pressure to be between a few to tens of Torrs or a few hundred Torrs, or atmospheric pressure;
h) one or more channels configured within the interface body, or in the sampler cone or in the insert, to introduce gases, reagents, dopants, samples, or analytes into the reaction chamber, allowing analytes to react via a gas-phase ion chemistry and be ionized in both negatively-and positively-charged states,
whereby the analytes in the present hybrid ICP-MS system can be introduced into the ICP torch or into the reaction chamber or into both, and by adjusting the reaction chamber pressure and temperature, the reaction chamber the hybrid ICP-MS is switched between elemental analysis and molecular analysis modes as well as allowing for soft ionization of samples.

2) The system of claim 1, wherein the insert has a plurality of apertures around the insert orifice, wherein the plurality of apertures is circular, arc slots, and annular, symmetrically or asymmetrically distributed around the insert orifice and wherein their number and opening areas are configured to obtain a predetermined reaction chamber pressure.

3) The system of claim 1, further having a rotatable disk with one or more apertures placed below or above the insert and configured to open and close the plurality of the apertures of the insert upon rotation, wherein the rotatable disk may be moved using a motor, actuator, pneumatically, manually, or via any other methods to switch between various modes of analysis,
whereby when the plurality of the apertures is open, the reaction chamber is not pressurized, thereby offering elemental analysis mode and when the plurality of the apertures is fully or partially closed, the reaction chamber is pressurized, thereby offering molecular analysis.

4) The system of claim 1, wherein the insert is mounted on the interface body beneath the sampler cone, or is mounted, assembled, or screwed onto the sampler cone to form the reaction chamber together with the sampler cone, wherein both the insert and sampler cone can be accessed and removed for cleaning, maintenance, and service purposes.

5) The system of claim 1, further having a gate valve implemented in the interface after the skimmer cone to be able to access the sampler cone, insert, and the skimmer cone without needing to break the vacuum, wherein when the gate valve is closed to retain the vacuum beyond the skimmer and avoid any issues for the vacuum pumps due to the high pressures or unnecessarily exposing the sensitive components inside the mass spectrometer to atmospheric air and contamination when servicing the interface and once the gate is closed, the sampler cone, insert, and the skimmer cone may be conveniently removed for cleaning purposes or replacement. This will also reduce the downtime of the instrument.

6) The system of claim 1, wherein the sampling interface is water cooled or air cooled to cool the sampler cone and prevent its orifice and sealing mechanisms from thermal damage or melting due to the high temperature of the plasma.

7) The system of claim 1, wherein the sampler orifice is between 0.5 to 3 mm, insert orifice is between 0.1 to 5 mm and the pumping speed is 30-50 m³/hr, resulting in the reaction chamber pressure between 2-760 Torrs.

8) The system of claim 1, wherein the pumping speed is variable between 10 to 100 m³/hr to adjust the reaction chamber pressure.

9) The system of claim 1, wherein the insert is electrically isolated from the interface and wherein a positive or a negative voltage is applied to the insert to focus ions exiting the insert as they travel toward the skimmer orifice and to extract ions emerging from the sampler orifice to improve ion transmission.

10) The system of claim 1, wherein the one or more channels are configured tangentially to the reaction chamber through one or a set of apertures distributed around the reaction chamber in order to generate a swirling flow for better mixing of species and improve homogeneity and reaction rates inside the reaction chamber.

11) The system of claim 1, wherein the insert is made of aluminum, nickel, copper, stainless steel, molybdenum, brass, or their alloys or compositions materials that have high thermal conductivity, high melting point, and high resistance against corrosion and oxidation to avoid overheating the insert with possible oxidation, melting, or thermal damage consequences.

12) The system of claim 1, wherein the surface of the insert is plated with gold, silver, or platinum to increase corrosion resistance and inhibit oxidation, or coated with ceramics or thermal barrier coatings.

13) A hybrid inductively coupled plasma mass spectrometer (ICP-MS) system to perform both elemental and molecular analysis in both positive and negative polarities, the system comprising:
a) an inductively coupled plasma (ICP) source having at least one inlet to receive a background gas and analytes, and to at least partially ionize the background gas and generate a plasma and plasma species comprising of ions that comprise of positive and negative ions, meta-stable ions and neutrals, and molecules of the background gas, and free electrons;
b) a mass spectrometer (MS)
c) an interface having an interface body and a sampler cone that has a sampler orifice and is placed in front of the plasma to intake ions and plasma species;
d) a first vacuum stage behind the sampler cone to create a first vacuum stage pressure of a few Torrs or lower behind the sampler cone using a first pump with a pumping speed;
e) a skimmer placed at a predefined distance behind the sampler orifice, wherein the skimmer has a central orifice to skim and partially intake the emerging flow of plasma species from the sampler orifice;
f) a second vacuum stage behind the skimmer cone to create a second vacuum stage pressure behind the skimmer using a second pump to further reduce the pressure and avoid recombination and neutralization of the ions;
g) a slider gate with one or more orifices that are actuated and moved manually or automatically to slide between the sampler and skimmer orifices to create a reaction chamber (zone) between the sampler cone and the slider gate, wherein the reaction chamber is characterized by a reaction chamber pressure that is controlled by the one or more orifices of the slider gate and the sampler orifice and the pumping speed of the first pump, allowing the reaction chamber pressure to be between a few to tens of Torrs or a few hundred Torrs, or atmospheric pressure
h) one or more channels configured within the interface body, or in the sampler cone to introduce gases, reagents, dopants, samples, or analytes into the reaction chamber, allowing analytes to react via a gas-phase ion chemistry and be ionized in both negatively-and positively-charged states,
whereby the analytes in the present hybrid ICP-MS system can be introduced into the ICP torch or into the reaction chamber or into both, and by adjusting the reaction chamber pressure and temperature, the reaction chamber the hybrid ICP-MS is switched between elemental analysis and molecular analysis modes as well as allowing for soft ionization of samples.

14) A hybrid inductively coupled plasma mass spectrometer (ICP-MS) system to perform both elemental and molecular analysis in both positive and negative polarities, the system comprising:
a) an inductively coupled plasma (ICP) source having at least one inlet to receive a background gas and analytes, and to at least partially ionize the background gas and generate a plasma and plasma species comprising of ions that comprise of positive and negative ions, meta-stable ions and neutrals, and molecules of the background gas, and free electrons;
b) a mass spectrometer (MS)
c) an interface having an interface body and a sampler cone that has a sampler orifice and is placed in front of the plasma to intake ions and plasma species;
d) a first vacuum stage behind the sampler cone to create a first vacuum stage pressure of a few Torrs or lower behind the sampler cone using a first pump with a pumping speed;
e) a skimmer placed at a predefined distance behind the sampler orifice, wherein the skimmer has a central orifice to skim and partially intake the emerging flow of plasma species from the sampler orifice;
f) a second vacuum stage behind the skimmer cone to create a second vacuum stage pressure behind the skimmer using a second pump to further reduce the pressure and avoid recombination and neutralization of the ions;
g) a circular gate comprising of a first and a second cylindrical parts, wherein the first cylindrical part has one or more apertures and it is stationary, and the second cylindrical part is rotatable, wherein a reaction chamber (zone) is created behind the sampler cone by turning the second cylindrical part to open and close the one or more apertures of the first part, allowing a reaction chamber pressure to be between a few to tens of Torrs or a few hundred Torrs, or atmospheric pressure;
h) one or more channels configured within the interface body, or in the sampler cone to introduce gases, reagents, dopants, samples, or analytes into the reaction chamber, allowing analytes to react via a gas-phase ion chemistry and be ionized in both negatively-and positively-charged states,
whereby the analytes in the present hybrid ICP-MS system can be introduced into the ICP torch or into the reaction chamber or into both, and by adjusting the reaction chamber pressure and temperature, the reaction chamber the hybrid ICP-MS is switched between elemental analysis and molecular analysis modes as well as allowing for soft ionization of samples.

15) A soft ionization method using a hybrid inductively coupled plasma mass spectrometer (ICP-MS) system having a ICP-MS interface to perform both elemental and molecular analysis in both positive and negative polarities, comprising steps of:
a) generating a plasma and plasma species comprising of ions that comprise of positive and negative ions, meta-stable ions and neutrals, and molecules of the background gas, and free electrons in a inductively coupled plasma (ICP) source having at least one inlet to receive a background gas and analytes;
b) creating a reaction chamber or zone between the sampler cone and the skimmer, wherein the reaction chamber is characterized by a reaction chamber pressure and temperature which are predetermined;
c) introducing gases, reagents, dopants, samples, analytes, fine solid aerosols, or nano-or micro-sprays into the reaction chamber;
d) controlling the reaction chamber pressure and temperature, to switched between elemental analysis and molecular analysis modes,
whereby introducing samples directly into the reaction chamber, provides condition for soft ionization of fragile molecules.

16) The method of claim 15, wherein to switch between elemental analysis and molecular analysis modes,
a) operating the plasma torch at high powers in the range of 700-1600 W for elemental analysis to fully decompose the sample and ionize the elements and avoid higher levels of oxides and molecular species, and introducing the sample through the ICP torch and for soft ionization of molecular samples, or
b) operating the plasma torch at lower powers in the range of 300-500 W or injecting higher-than-optimum carrier gas flow rate to avoid decomposing the molecules of interest by offering a colder plasma, in this manner, the plasma will generally act as an evaporator, desolvator, or thermal desorption system and the soft ionization process will mainly happen inside the reaction chamber.

17) The method of claim 15, injecting a reagent gas into the reaction chamber to neutralize dominant argon ions and metastables generated by the ICP source, wherein the reagent gas is selected from a group including nitrogen, helium, oxygen, nitrous oxide, acetone, SF₆, nitric oxide, nitrogen dioxide, methane, krypton, xenon, carbon monoxide, carbon dioxide, carbon disulfide, and sulfur dioxide, to neutralize Ar⁺, ArH⁺, ArO⁺, ArCl⁺, or Ar₂⁺ thereby enabling interference-free analysis of elements including but not limited to calcium, potassium, iron, arsenic, or selenium, respectively, that experience interference from argon background ions.

18) The method of claim 15, wherein the reaction chamber pressure and temperature is controlled by providing: an insert having an insert orifice, a geometry, and a form factor, placed between a sampler cone and a skimmer of the ICP-MS interface, wherein the insert orifice allows plasma species to pass through toward the skimmer orifice.

19) The method of claim 15, wherein the reaction chamber pressure and temperature are controlled by providing an insert having a central insert orifice and plurality of peripheral apertures that can be open, partially closes or fully closed by a rotatable disk.

20) The method of claim 15, configuring the reaction chamber pressure and temperature to allow for samples or analytes directly introduced into the reaction chamber go through a soft ionization process by charge transfer, proton transfer, oxygen transfer, electron attachment, Penning ionization, chemical ionization, or adduct formation, wherein samples or analytes react with the positive and negative ions, meta-stable ions and neutrals, and molecules of the background gas, and free electrons generated by the inductively coupled plasma (ICP) source to form new ions that can be analyzed by the mass spectrometer.
